(19) United States
(12) Patent Application Publication
(10) Pub. No.: US 2026/0231144 A1
(43) Pub. Date: Aug. 6, 2026

(54) METHODS FOR SELECTION OF SCHEDULING REQUEST RESOURCES IN FULL DUPLEX SYSTEMS

(71) Applicant: InterDigital Patent Holdings, Inc., Wilmington, DE (US)

(72) Inventors: Jongwoo Hong, New York, NY (US); Jonghyun Park, Syosset, NY (US); Moon IL Lee, Melville, NY (US); Paul Marinier, Brossard (CA); Nazli Khan Beigi, Longueuil (CA); Aata El Hamss, Laval (CA); Virgile Garcia, Antibes (FR)

(73) Assignee: InterDigital Patent Holdings, Inc., Wilmington, DE (US)

(21) Appl. No.: 19/044,141

(22) Filed: Feb. 3, 2025

(51) Int. Cl. H04W 72/1268; H04L 5/14

(52) U.S. Cl. CPC H04W 72/1268; H04L 5/14

(57) ABSTRACT

A method performed by a WTRU may comprise: receiving, from a network, configuration information including a first set of SR IDs, wherein the first set of SR IDs includes a first SR ID; determining at least one of the following: (1) a CLI level of a first PUCCH resource associated with the first SR ID; (2) a transmission power of the first PUCCH resource associated with the first SR ID; and/or (3) a bit rate of data to be transmitted; determining that a condition is satisfied; based on the determination that the condition is satisfied, selecting the first SR ID; and transmitting a SR via the first PUCCH resource associated with the first SR ID. The PUSCH resources associated with the first SR ID may include SBFD symbols.

### BACKGROUND

In New Radio (NR), duplex operation enhances traditional time division duplex (TDD) by improving uplink coverage, increasing capacity, reducing latency, and providing other performance benefits. Conventional TDD operates by dividing the time domain between uplink and downlink transmissions. In current wireless standards, cross link interferences (CLI) measurement and reporting mechanisms are network-initiated. For example, the network may configure a wireless transmit/receive unit (WTRU) to perform CLI measurements (e.g., layer-3 (L3)-CLI-RSSI, L3-SRS-RSRP) and report the results back to the network. However, the WTRU is often the first to detect changes in CLI based on its configured measurement resources. These variations remain unknown to the network until the WTRU sends a report. This asynchronous reporting process introduces additional latency and increases signaling overhead, as the network must wait for and process WTRU-reported CLI updates.

### SUMMARY

A method performed by a WTRU may comprise: receiving, from a network, configuration information including a first set of scheduling request (SR) IDs, wherein the first set of SR IDs includes a first SR ID; determining at least one of the following: (1) a cross-link interference (CLI) level of a first physical uplink control channel (PUCCH) resource associated with the first SR ID; (2) a transmission power of the first PUCCH resource associated with the first SR ID; and/or (3) a bit rate of data to be transmitted; determining that a condition is satisfied; based on the determination that the condition is satisfied, selecting the first SR ID; and transmitting a SR via the first PUCCH resource associated with the first SR ID. The condition may be satisfied if one or more of the following is satisfied: (1) the CLI level is below a configured CLI threshold; (2) the transmission power is below a transmission power threshold; and/or (3) the bit rate is below a data bit rate threshold. The PUSCH resources associated with the first SR ID may include SBFD symbols.

A method performed by a WTRU may comprise: receiving, from a network, configuration information including a first set of SR IDs and a second set of SR IDs, wherein the first set of SR IDs includes a first SR ID and the second set of SR IDs include a second SR ID; determining at least one of the following: (1) a CLI level of a PUCCH resource associated with the first SR ID included in the first set of SR IDs; (2) a transmission power of the PUCCH resource associated with the first SR ID included in the first set of SR IDs; and/or (3) a bit rate of data to be transmitted; determining that a condition is satisfied; based on the determination that the condition is satisfied, selecting the second SR ID included in the second set of SR IDs; transmitting a SR via a PUCCH resource associated with the second SR ID. The condition may be satisfied if one or more of the following is satisfied: (1) the CLI level is above a configured CLI threshold; (2) the transmission power is above a transmission power threshold; and/or (3) the bit rate is above a data bit rate threshold. The PUSCH resources associated with the second SR ID may include non-SBFD symbols.

A WTRU may be configured to: receive, from a network, configuration information including a first set of scheduling request (SR) IDs and a second set of SR IDs, wherein the first set of SR IDs include a first SR ID and the second set of SR IDs include a second SR ID; determine at least one of the following: (1) a CLI level of a PUCCH resource associated with the first SR ID; (2) a transmission power of the PUCCH resource associated with the first SR ID; and (3) a bit rate of data to be transmitted; determine whether a condition is satisfied. On a condition that the condition is satisfied: select the first SR ID included in the first set of SR IDs and transmit a first SR via the first PUCCH resource associated with the first SR ID. On a condition that the condition is not satisfied: select the second SR ID and transmit a second SR via a second PUCCH resource associated with the second SR ID. The condition may be satisfied if one or more of the following is satisfied: (1) the CLI level is below a configured CLI threshold; (2) the transmission power is below a transmission power threshold; and/or (3) the bit rate is below a data bit rate threshold. The PUSCH resources associated with the first SR ID may include SBFD symbols. The PUSCH resources associated with the second SR ID may include non-SBFD symbols.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example SBFD configuration in TDD;

FIG. 3 illustrates an example of CLI between inter-BSs and inter-WTRUs;

FIG. 4 illustrates an exemple DCI field of a DCI for unified TCI-state indications;

FIG. 5 illustrates an exemplary signaling diagram for SR ID selection;

FIG. 6 illustrates an exemplary selection of a SR ID from a first set of SR IDs;

FIG. 7 is illustrates an exemplary SR ID selection process according to an embodiment;

FIG. 8 illustrates an exemplary SR ID selection process according to an embodiment; and

FIG. 9 illustrates an exemplary SR ID selection process according to an embodiment.

### DETAILED DESCRIPTION

The following acronyms and abbreviations may be referred to:
ACK Acknowledgement
BLER Block Error Rate
BS Base Station
BSR Buffer Status Report
BWP Bandwidth Part
CG Configured grant
C-JT Coherent Joint Transmission
CLI Cross-Link Interference
CLPC Closed Loop Power Control
CORESET Control Resource Set
CP Cyclic Prefix
CP-OFDM Conventional OFDM (relying on cyclic prefix)
CQI Channel Quality Indicator
CRC Cyclic Redundancy Check
cri-RSRP CSI-RS resource indicator-RSRP
CRMR CLI-RSSI Measurement Resource
CRS Cell-specific RS
CSI Channel State Information
DAI Downlink Assignment Index
DCI Downlink Control Information
DG Dynamic grant
DL Downlink
DM-RS Demodulation Reference Signal
DRB Data Radio Bearer
EMBB Enhanced Mobile Broadband
FD Full Duplex
HARQ Hybrid Automatic Repeat Request
HD Half Duplex
IAB Integrated Access and Backhaul
L1-RSRP Layer1-RSRP
LTE Long Term Evolution e.g. from 3GPP LTE R8 and up
MAC CE MAC control element
MCS Modulation and Coding Scheme
MIMO Multiple Input Multiple Output
mTRP Multiple TRP
NACK Negative ACK
NC-JT Non-Coherent Joint Transmission
NG-RAN Next Generation RAN
NR New Radio
OFDM Orthogonal Frequency-Division Multiplexing
OLPC Open Loop Power Control
PC Power Control
PDCCH Physical Downlink Control Channel
PDSCH Physical Downlink Shared Channel
PH Power Headroom
PHR Power Headroom Report
PHR Power Headroom Reporting
PHY Physical Layer
PL Pathloss
PMI Precoding Matrix Indicator
P-MPR Power Management-Maximum Power Reduction
PRACH Physical Random Access Channel
PSS Primary Synchronization Signal
PUCCH Physical Uplink Control Channel
PUSCH Physical Uplink Shared Channel
RACH Random Access Channel (or procedure)
RAN Radio Access Network
RAR Random Access Response
RB Resource Block
RE Resource Element
RF Radio Front end
RLF Radio Link Failure
RLM Radio Link Monitoring
RNTI Radio Network Identifier
RRC Radio Resource Control
RRM Radio Resource Management
RS Reference Signal
RSRP Reference Signal Received Power
RSSI Received Signal Strength Indicator
SBFD Subband Non-Overlapping Full Duplex
SDU Service Data Unit
SI Self-Interference
SFI Slot Format Indicator
SINR Signal-to-Interference-plus-Noise Ratio
SL Sidelink (Side Link)
SPS Semi-persistent scheduling
SR Scheduling Request
SRI SRS Resource Indicator
SRS Sounding Reference Signal
SRS Sounding Reference Signal
SS Synchronization Signal
SSB Synchronization Signal Block
SSS Secondary Synchronization Signal
SUL Supplemental Uplink
TB Transport Block
TBS Transport Block Size
TCI Transmission Configuration Indicator
TDD Time Division Duplex
TRP Transmission/Reception Point
UCI Uplink Control Information
UE User Equipment
UL Uplink
URLLC Ultra-Reliable and Low Latency Communications
WLAN Wireless Local Area Networks and related technologies (IEEE 802.xx domain)
WTRU Wireless Transmit/Receive Unit
XDD Cross Division Duplex

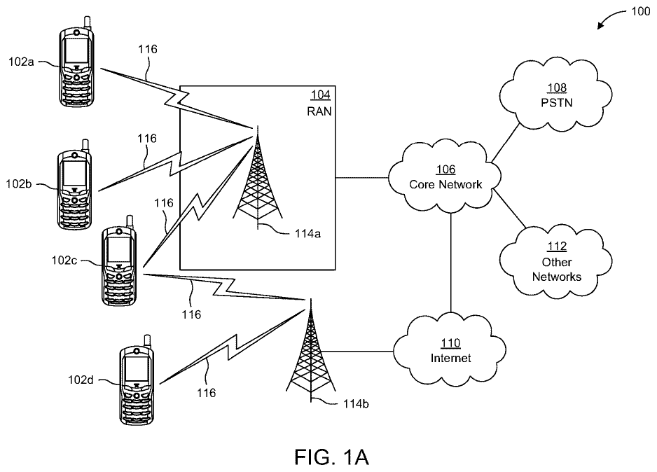

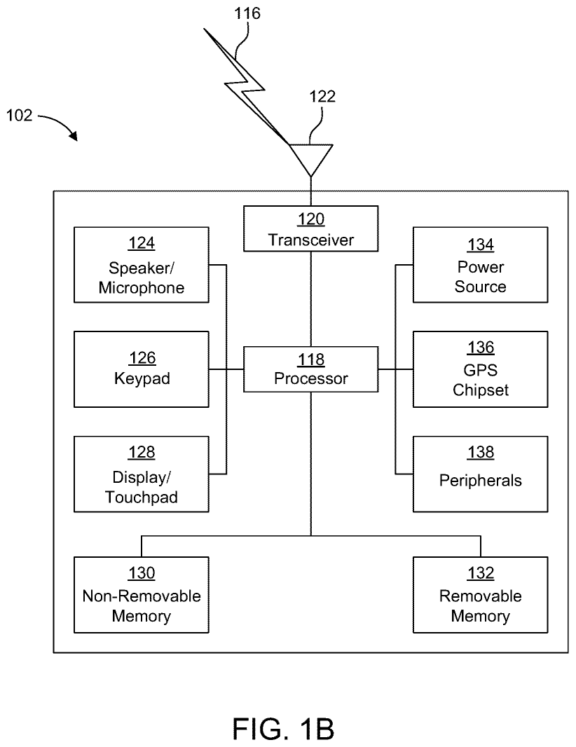

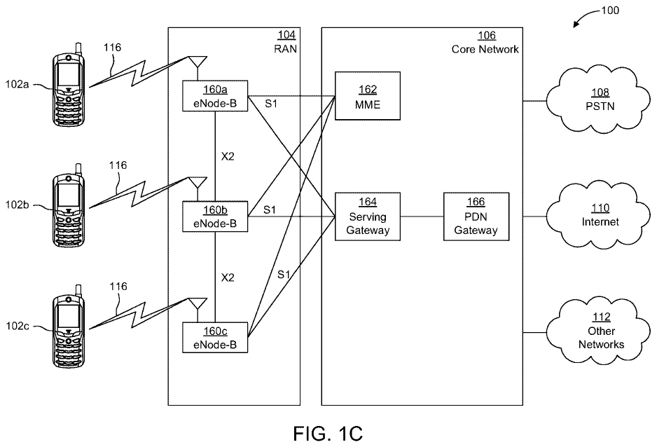

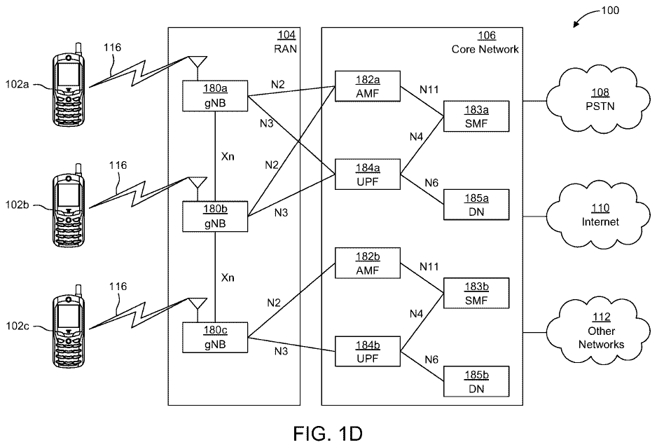

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S 1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU)

sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

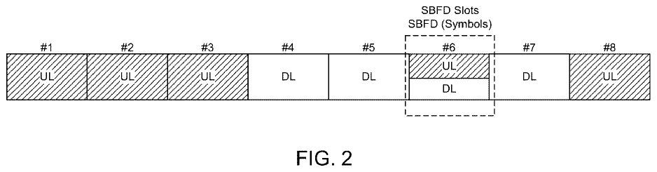

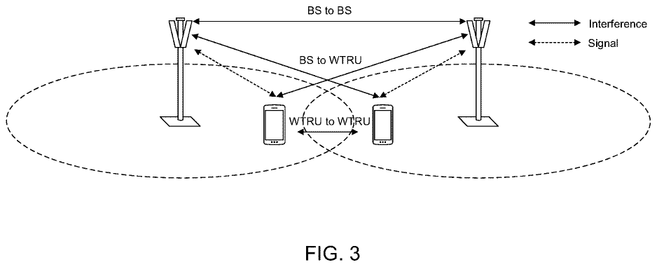

In NR, duplex operation enhances traditional TDD by improving UL coverage, increasing capacity, reducing latency, and providing other performance benefits. Conventional TDD operates by dividing the time domain between uplink and downlink transmissions. In current wireless standards, CLI measurement and reporting mechanisms are network-initiated. For example, the network may configure a WTRU to perform CLI measurements (e.g., layer-3 (L3)-CLI-RSSI, L3-SRS-RSRP) and report the results back to the network. However, the WTRU is often the first to detect changes in CLI based on its configured measurement resources. These variations remain unknown to the network until the WTRU submits a report. This asynchronous reporting process introduces additional latency and increases signaling overhead, as the network must wait for and process WTRU-reported CLI updates. FIG. 2 illustrates an exemplary SBFD configuration in TDD. FIG. 3 illustrates an example of CLI between inter-BSs and inter-WTRUs.

When new data is triggered, a WTRU may select a scheduling request ID (SR ID)-associated PUCCH resource and transmit a request via the PUCCH to obtain a PUSCH resource. If the WTRU selects an SR ID-associated PUCCH resource (e.g., SBFD-symbols) experiencing high CLI levels, the SR transmission may fail due to excessive CLI interference. The challenge, therefore, is determining how the WTRU can optimally select an SR ID-associated PUCCH to ensure successful SR transmission and reliable reception of an uplink grant when using SBFD-symbols.

Hereinafter, the term WTRU may be used interchangeably with the terms “SBFD aware WTRU,” “full duplexing WTRU,” and “full duplex capability WTRU.” Hereinafter, the term “network” may be used interchangeably with BS, gNB, eNB, and/or NG-RAN.

Hereinafter, the terms “a” and “an” are similar phrases and are to be interpreted as “one or more” and “at least one.” Hereinafter, any term which ends with the suffix “(s)” is to be interpreted as “one or more” and “at least one.” Hereinafter, the term ‘may’ is to be interpreted as “may” and/or “for example.” Hereinafter, a symbol ‘/’ (e.g., forward slash) may be used herein to represent “and/or”, where for example, ‘A/B’ may imply ‘A and/or B’.

Hereinafter, the term “subband” may be used to refer to a frequency-domain resource and may be characterized by at least one of the following: a set of RBs, a set of RBs (RB sets) (e.g., when a carrier has intra-cell guard bands, a set of interlaced resource blocks, a BWP, or portion thereof, and/or a carrier, or portion thereof). For example, a subband may be characterized by a starting RB and number of RBs for a set of contiguous RBs within a BWP. A subband may also be defined by the value of a frequency-domain resource allocation field and bandwidth part index.

Hereinafter, the term “XDD” may be used to refer to a subband-wise duplex (e.g., either UL or DL being used per subband) and may be characterized by at least one of the following: cross division duplex (e.g., subband-wise FDD within a TDD band); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (SBFD) (e.g., non-overlapped sub-band full-duplex); a full duplex other than a same-frequency (e.g., spectrum sharing, subband-wise-overlapped) full duplex; and/or an advanced duplex method, e.g., other than (pure) TDD or FDD.

Hereinafter, the term “dynamic(/flexible) TDD” may be used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). For example, in a system employing dynamic/flexible TDD, a component carrier(CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first BS employing dynamic/flexible TDD may transmit a DL signal to a first WTRU being communicated/associated with the first BS based on a first SFI and/or tdd-UL-DL-config configured/indicated by the first BS, and a second BS (e.g., cell, TRP) employing dynamic/flexible TDD may receive an uplink signal transmitted from a second WTRU being communicated/associated with the second BS based on a second SFI and/or tdd-UL-DL-config configured/indicated by the second BS. For example, the first WTRU may determine that the reception of the DL signal is being interfered by the UL signal, where the interference caused by the UL signal may be referred to as a “WTRU-to-WTRU CLI.”

A WTRU may transmit or receive a physical channel or reference signal according to at least one spatial domain filter. Hereinafter, the term “beam” may be used to refer to a spatial domain filter.

The WTRU may transmit a physical channel or signal using the same spatial domain filter as the spatial domain filter used for receiving an RS (such as CSI-RS) or a SS block. Hereinafter, the WTRU transmission may be referred to as “target”, and the received RS or SS block may be referred to as a “reference” or a “source.” The WTRU may transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. The WTRU may transmit the first (target) physical channel or signal according to a spatial relation with a reference to the second (reference) physical channel or signal.

A spatial relation may be implicit, configured by RRC, or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such an association may exist between a physical channel such as PDCCH or PDSCH and its respective DM-RS. When the first and second signals are reference signals, an association may exist when the WTRU is configured with a quasi-colocation (QCL) assumption type D between corresponding antenna ports. The association may be configured as a transmission configuration indicator (TCI) state. A WTRU may be indicated an association between a CSI-RS or SS block and a DM-RS by an index to a set of TCI states configured by RRC and/or signaled by MAC CE. The indication may also be referred to as a “beam indication.”

A WTRU may receive transmit configuration indication(TCI) related configuration(s), for example, including a plurality of TCI-states (e.g., an RRC-configured pool of TCI-states (e.g., as unified TCI framework), ‘TCI-State’ IE, ‘TCI-UL-State’ IE, and/or ‘spatialRelationInfo’ IE). A TCI-state of the plurality of TCI-states may be associated with at least one of QCL-info #1, QCL-info #2, additionalPCI, pathloss RS(PLRS)-ID, UL-PC, Timing Advance Group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID.

In an example, the UL-PC (e.g., UL-PC parameter set, which may comprise at least one of P0, alpha, close-loop(CL)-index, power offset, etc.) may be for determining an uplink power for an UL transmission associated with the TCI-state. In an example, the additionalPCI may be a physical cell-ID (PCID) of a neighboring (e.g., surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command(TAC)(s)) in association with the TAG-ID (e.g., of multiple TAG-IDs being configured) to a scheduled UL transmission.

In one example, the UL-PC configuration (e.g., a UL-PC parameter set, which may include at least one of P0, alpha, closed-loop (CL) index, power offset, etc.) may be used to determine the uplink transmission power for a transmission associated with a transmission configuration indicator (TCI) state. Additionally, the additionalPCI parameter may represent the physical cell ID (PCID) of a neighboring (e.g., surrounding) cell. The RS associated with the TCI state (e.g., such as a SSB index or CSI-RS), may be transmitted from this neighboring cell, potentially serving as an inter-cell beam reference or RS reference. Furthermore, a WTRU may apply a timing advance (TA) value, which is determined based on received timing advance command (TAC) messages, in association with a timing advance group identifier (TAG-ID). This applies particularly when multiple TAG-IDs are configured for a scheduled uplink transmission.

For example, typeA may represent {Doppler shift, Doppler spread, average delay, delay spread}, typeB may represent {Doppler shift, Doppler spread}, typeC may represent {Doppler shift, average delay}, and typeD may represent {Spatial Rx parameter}.

Doppler shift, Doppler spread, average delay, delay spread, Spatial Rx parameter may be based on the indicated QCL-type, and apply the at least one parameter for transmission or reception of the physical channel or signal.

A unified TCI (e.g., a common TCI, a common beam, a common RS, etc.) may refer to a beam/RS to be (simultaneously) used for multiple physical channels/signals. Hereinafter, the term “TCI” may comprise at least a TCI state that includes at least one source RS to provide a reference (e.g., WTRU assumption) for determining QCL and/or spatial filter.

In an example, a WTRU may receive (e.g., from the network) an indication of a first unified TCI to be used/applied for both a downlink control channel (e.g., PDCCH) and a downlink shared channel (e.g., PDSCH) (e.g., and a downlink RS). The source reference signal(s) in the first unified TCI may provide common QCL information at least for a WTRU-dedicated reception on the PDSCH and all (or subset of) CORESETs in a CC. In an example, a WTRU may receive (e.g., from a network) an indication of a second unified TCI to be used/applied for both an uplink control channel (e.g., PUCCH) and an uplink shared channel (e.g., PUSCH) (e.g., and an uplink RS). The source reference signal(s) in the second unified TCI may provide a reference for determining common UL TX spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode, a parameter of unifiedTCI-StateType set to “separate”) where an indicated unified TCI (e.g., the first unified TCI or the second unified TCI) may be applicable for either downlink (e.g., based on the first unified TCI) or uplink (e.g., based on the second unified TCI).

A WTRU may receive (e.g., from a network, a BS, a gNB, and/or a TRP.) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode, a parameter of unifiedTCI-StateType set to “joint”) where an indicated unified TCI (e.g., the third unified TCI) may be applicable for both DL and UL (e.g., based on the third unified TCI).

A WTRU may determine a TCI state applicable to a transmission or reception by first identifying a unified TCI state instance (e.g., a TCI-state group, a group of TCI states, or a set of activated TCI states) that applies to the transmission or reception. The WTRU may then determine the specific TCI state corresponding to this unified TCI state instance. A transmission may include at least PUCCH, PUSCH, or SRS, while a reception may include at least PDCCH, PDSCH, or CSI-RS. The unified TCI state instance may also be referred to as a TCI state group, TCI state process, unified TCI pool, a group of TCI states, or a set of time-domain instances (e.g., slots, symbols, time stamps) and/or frequency-domain instances (e.g., RBs, subbands).

Additionally, a unified TCI state instance may correspond to or be identified by a Coreset Pool identity (e.g., CORESETPoolIndex, a TRP indicator, or similar parameters).

Hereafter, the term “unified TCI” may be interchangeably used with one or more of unified TCI-states, unified TCI instance, TCI, and/or TCI-state.

A WTRU may be configured with multiple transmission configuration indicator states (e.g., unified TCI states), each applicable to multiple channels and/or signals. These channels and signals may be configured, pre-determined, or defined for the WTRU—potentially provided in the form of a list—via higher-layer signaling such as RRC and/or MAC-CE. The configured channels/signals may include, individually or in combination, one or more CORESETs, PDCCH candidates, search spaces, PDSCH transmissions (e.g., occasions, configurations, or instances), RSs (e.g., CSI-RSs, DMRSs, SSB indexes, PRSs, PTRSs, and/or SRSs), PUSCH transmissions (e.g., occasions, configurations, or instances), PUCCH resources (e.g., resource sets or groups), and/or PRACH occasions, resources, or RSs.

The plurality of TCI states may be configured via RRC signaling (e.g., and/or via a MAC-CE signaling, indication or activation). A WTRU may receive, for example, via a MAC-CE or separate signaling, information content that includes a mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

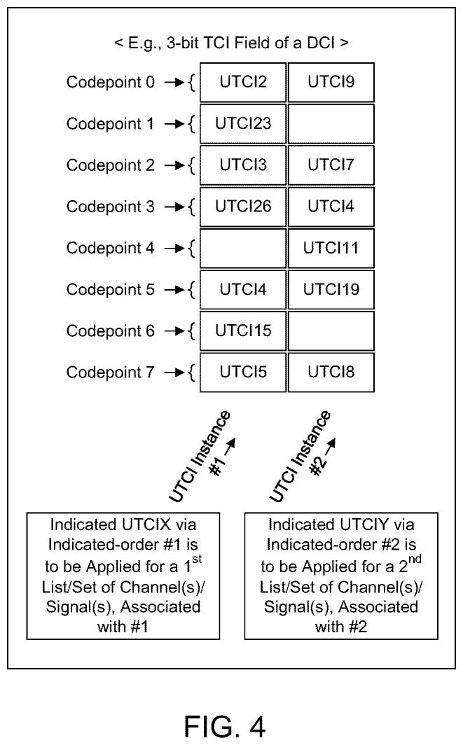

FIG. 4 illustrates an exemplary DCI field (e.g., TCI field) of a DCI for unified TCI-state indications. As shown in FIG. 4, the WTRU may receive (e.g., via MAC-CE signaling) the mapping between a codepoint of the DCI field and one or more TCI states. For example, Codepoint 2 may be mapped to {UTCI3, UTCI7}, where the WTRU may apply at least one of {UTCI3, UTCI7} to the multiple channel(s)/signal(s) (e.g., based on a list of the multiple channel(s)/signal(s) configurable by a higher-layer signaling from a BS). The list of the multiple channel(s)/signal(s) may be given per UTCI instance (e.g., TCI-state group, a group of TCI-states, a set of activated TCI-states), where the UTCI instance may correspond to each column of the mapping table, illustrated in the figure, between a codepoint and the one or more TCI states.

Hereinafter, the term “TRP” may be interchangeably used with one or more of: a transmission point (TP), reception point (RP), radio remote head (RRH), distributed antenna (DA), BS, a sector of a BS, and a cell (e.g., a geographical cell area served by a BS). Hereinafter, the term “multi-TRP” may be interchangeably used with one or more of: MTRP, M-TRP, and/or multiple TRPs.

A WTRU may report a subset of CSI components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), CQI, precoding matrix indicator (PMI), layer index, and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, and/or cell switching.

A WTRU may measure and report the CSI, wherein the CSI for each connection mode may include or be configured with one or more of following:

The CSI for each connection mode may include or be configured with a CSI report configuration, including one or more of the following: CSI report quantity (e.g., CQI, RI, PMI, CRI, and/or layer indicator); a CSI report type (e.g., aperiodic, semi persistent, and/or periodic); a CSI report codebook configuration (e.g., Type I, Type II, and/or Type II port selection); and/or a CSI report frequency.

The CSI for each connection mode may include or be configured with a CSI-RS resource set, including one or more of the following CSI resource settings: a NZP-CSI-RS Resource for channel measurement; a NZP-CSI-RS resource for interference measurement; and/or a CSI-IM Resource for interference measurement.

The CSI for each connection mode may include or be configured with NZP CSI-RS resources, including one or more of the following: NZP CSI-RS Resource ID; periodicity and offset; QCL information and TCI-state; and/or resource mapping (e.g., number of ports, density and/or CDM type).

A WTRU may indicate, determine, and/or be configured with one or more reference signals. The WTRU may monitor, receive, and/or measure one or more parameters based on the respective reference signals.

A WTRU may monitor, receive, and/or measure SS-RSRP. SS-RSRP may be measured based on the synchronization signals (e.g., DMRS in PBCH and/or SSS). SS-RSRP may be defined as the linear average over the power contribution of the RE that carry the respective synchronization signal. In measuring the RSRP, power scaling for the reference signals may be required. If SS-RSRP is used for L1-RSRP, the measurement may be accomplished based on CSI reference signals in addition to the synchronization signals.

A WTRU may monitor, receive, and/or measure CSI-RSRP. The WTRU may measure the CSI-RSRP based on the linear average over the power contribution of the REs that carry the respective CSI-RS. The CSI-RSRP measurement may be configured within measurement resources for the configured CSI-RS occasions.

A WTRU may monitor, receive, and/or measure SS-SINR. SS-SINR may be measured based on the synchronization signals (e.g., DMRS in PBCH or SSS). SS-SINR may be defined as the linear average over the power contribution of the REs that carry the respective synchronization signal divided by the linear average of the noise and interference power contribution. If SS-SINR is used for L1-SINR, the noise and interference power measurement may be accomplished based on resources configured by higher layers.

A WTRU may monitor, receive, and/or measure CSI-SINR. CSI-SINR may be measured based on the linear average over the power contribution of the REs that carry the respective CSI-RS divided by the linear average of the noise and interference power contribution. If CSI-SINR is used for L1-SINR, the noise and interference power measurement may be accomplished based on resources configured by higher layers. The noise and interference power may be measured based on the resources that carry the respective CSI-RS.

A WTRU may monitor, receive, and/or measure RSSI. RSSI may be measured based on the average of the total power contribution in configured OFDM symbols and bandwidth. The power contribution may be received from different resources (e.g., co-channel serving and non-serving cells, adjacent channel interference, and/or thermal noise)

A WTRU may monitor, receive, and/or measure CLI-RSSI. CLI-RSSI may be measured based on the average of the total power contribution in configured OFDM symbols of the configured time and frequency resources. The power contribution may be received from different resources (e.g., cross-link interference, co-channel serving and non-serving cells, adjacent channel interference, and/or thermal noise).

A WTRU may monitor, receive, and/or measure SRS-RSRP. SRS-RSRP may be measured based on the linear average over the power contribution of the REs that carry the respective SRS.

A property of a grant or assignment may include at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by MAC or by RRC for the scheduling the grant or assignment.

An indication by DCI may include at least one of the following: an explicit indication by a DCI field or by RNTI used to mask CRC of the PDCCH and/or an implicit indication by a property such as DCI format, DCI size, CORSET or search space, aggregation Level, first resource element of the received DCI (e.g., index of first control channel element), where the mapping between the property and the value may be signaled by RRC or MAC.

Hereinafter, the term “signal” may be interchangeably used with one or more of following: SRS, CSI-RS, DM-RS, PT-RS, and/or SSB. Hereafter, a channel may be interchangeably used with one or more of following: PDCCH, PDSCH, PUCCH, PUSCH, and/or PRACH. Hereinafter, the term “downlink reception” may be used interchangeably with Rx occasion, PDCCH, PDSCH, SSB reception. Hereinafter, the term “uplink transmission” may be used interchangeably with Tx occasion, PUCCH, PUSCH, PRACH, SRS transmission. Hereinafter, the term “RS” may be interchangeably used with one or more of RS resource, RS resource set, RS port, RS port group, SSB, CSI-RS, SRS and DM-RS.

Hereinafter, the term “time instance” may be interchangeably used with slot, symbol, subframe. Hereinafter, the term “UTCI” may be interchangeably used with TCI, UTCI state, TCI state. Hereinafter, the terms “UL-only Tx occasions” and “DL-only Rx occasions” may interchangeably be used with legacy TDD UL or legacy TDD DL, respectively. For example, the legacy TDD UL/DL Tx/Rx occasions may be the cases where SBFD is not configured and/or where SBFD is disabled.

Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably.

Hereinafter, the term “UL signal” (e.g., SRS, DMRS, PUSCH, PUCCH, PRACH, PTRS, etc.) may be used interchangeably with a UL signal or channel, or a UL channel or signal, but still consistent with this invention. Hereinafter, the term “DL signal” (e.g., CSI-RS, SSB, PDSCH, PDCCH, PBCH, PTRS, etc.) may be used interchangeably with a DL signal or channel, or a DL channel or signal.

A WTRU may be configured with one or more types of slots within a bandwidth, wherein a first type of slot may be used or determined for a first direction (e.g., downlink, or sidelink (e.g., WTRU-to-WTRU communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction.

Hereinafter, the term “bandwidth” may be interchangeably used with bandwidth part (BWP), carrier, subband, and system bandwidth; Hereinafter, the term “first type of slot” (e.g., the slot for a first direction) may be referred to as downlink (and/or sidelink) slot. Hereinafter, the term “second type of slot” (e.g., slot for a second direction) may be referred to as uplink (and/or sidelink) slot. Hereinafter, the term “third type of slot” may be referred to as Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)).

Hereinafter, the term “group of frequency resource for a first direction” may be referred to as downlink (and/or sidelink) subband, downlink (and/or sidelink) frequency resource, or downlink (and/or sidelink) RBs. Hereinafter, the term “group of frequency resource for a second direction” may be referred to as uplink (and/or sidelink) subband, uplink (and/or sidelink) frequency resource, or uplink (and/or sidelink) RBs. Hereinafter, the term “group of frequency resource for a flexible direction” (e.g., that can be configured for a first direction, second direction, etc.) may be referred to as flexible subband, flexible frequency resource, or flexible RBs. Hereinafter, the term “group of frequency resource between a first direction and a second direction” may be referred to as guard band, guard frequency resource, or guard RBs.

In an example, a SBFD-enabled WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands.

For example, the SBFD configuration may include a flag signal (e.g., enabled/disabled), where a first value (e.g., ‘0’) indicates a first mode of operation (e.g., SBFD configuration), and a second value (e.g., ‘1’ may indicate a second mode of operation (e.g., non-SBFD operation). The modes of operation (e.g., SBFD and/or non-SBFD) may be indicated via MIB, SIB, RRC, MAC-CE, and/or DCI.

The WTRU may receive the time resources (e.g., one or more symbols, slots, and so forth), for which the first mode of operation (e.g., SBFD) is defined in, for example, one or more BWPs, subbands, component carriers (CC), cells, and so forth. The WTRU may receive the frequency resources (e.g., subbands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. For example, the time instances may be indicated via a bitmap configuration, where each bit corresponds to a time instance (e.g., slot, symbol, subframe, etc.) and each bit indication indicates whether corresponding time instance can be used for the first or second mode of operation.

A WTRU may be configured with a DL TDD configuration for a component carrier or a BWP for one or more Rx occasions (e.g., via tdd-UL-DL-config-common, dedicated configurations, and/or SFI). If the first mode of operation (e.g., SBFD) is configured, one or more of the configured frequency resources (e.g., subbands, PRBs, and/or BWPs) may be configured for the transmission in UL channels and/or Tx occasions.

A WTRU may be configured with an UL TDD configuration for a component carrier or a BWP for one or more Tx occasions (e.g., via tdd-UL-DL-config-common, dedicated configurations, and/or SFI). If the first mode of operation (e.g., SBFD) is configured, one or more of the configured frequency resources (e.g., subbands, PRBs, and/or BWPs) may be configured as the DL channels and/or Rx occasions.

A WTRU may be configured with a DL, UL, or flexible TDD configuration for a component carrier or a BWP for one or more Rx/Tx occasions (e.g., via tdd-UL-DL-config-common, dedicated configurations, and/or SFI). If the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., ‘0’) may indicate a first direction (e.g., UL duplexing mode), and a second the value (e.g., ‘1’) may indicate a second direction (e.g., DL duplexing model). The duplexing mode configuration and/or flag for the first mode of operation (e.g., SBFD) may be configured as part of modes of operation configuration, for example via MIB, SIB, RRC, DCI, and/or MAC-CE. The duplexing mode configuration and/or flag for the first mode of operation (e.g., SBFD) may be configured as part of resource allocation configuration for a Tx/Rx occasion.

A WTRU may be configured with one or more types of slots. The WTRU may be configured with a first slot with a first type, where the first type may be, for example, a SBFD slot. The WTRU may be configured with a second slot with a second type, where the second type may be, for example, a non-SBFD slot. As for the first slot with the first type (SBFD), the WTRU may be configured with one or more DL, UL, flexible, and/or guard subbands in the frequency domain, throughout the BWP, for the duration of the first slot. However, in the second slot with the second type (non-SBFD), the WTRU may be configured with only one direction type, for example, DL, UL, and/or flexible, in the frequency domain, throughout the BWP, for the duration of the second slot.

In an example, if the WTRU is configured with a second slot with UL direction, this may indicate legacy TDD UL slot, UL-only slot, and/or non-SBFD UL slot. In another example, if the WTRU is configured with a third slot with second type (non-SBFD) with DL direction, this may indicate legacy TDD DL slot, DL-only slot, and/or non-SBFD DL slot. In another example, if the WTRU is configured with a fourth slot with second type (non-SBFD) with flexible direction, this may indicate legacy TDD flexible slot and/or non-SBFD flexible slot.

A WTRU may receive configuration information (e.g., may be configured with) that includes SBFD subband time locations that may be configured within a period. For example, the period may be the same as TDD-UL-DL pattern period configured by dl-UL-TransmissionPeriodicity (e.g., in TDD-UL-DL-ConfigCommon). The period may be an integer multiple of TDD-UL-DL pattern period configured by dl-UL-TransmissionPeriodicity (e.g., in TDD-UL-DL-ConfigCommon).

When a TDD-UL-DL pattern is configured, SBFD symbols may be configured in a consecutive manner within a TDD-UL-DL pattern period. When two TDD-UL-DL patterns are configured, and if SBFD symbols are configured for only one of the patterns, SBFD symbols may be configured in consecutive manner within the TDD-UL-DL pattern period. When two TDD-UL-DL patterns are configured, and if SBFD symbols are configured for both patterns, SBFD symbols may be configured in consecutive manner within each TDD-UL-DL pattern period.

A WTRU may determine (and/or be indicated/configured with) that UL usable PRBs are a part of UL subband frequency resources within an UL BWP (e.g., an active UL BWP and/or a currently active UL BWP), and DL usable PRBs are a part of DL subband frequency resources within an DL BWP (e.g., an active DL BWP, a currently active DL BWP). The UL usable PRBs may be determined as an intersection between a configured or indicated UL subband and an active UL BWP in SBFD symbols and/or slots. The DL usable PRBs may be determined as an intersection between a configured or indicated DL subband(s) and an active DL BWP in SBFD symbols (and/or slots). The UL and/or DL usable PRBs may be explicitly configured within active UL and/or DL BWP, e.g., in SBFD symbols and/or slots.

In an example, a WTRU may receive information associated with frequency resource allocation (e.g., Type 0 as RBG-level bitmap-based resource assignment) for a PDSCH or PUSCH (as being scheduled) in a slot(s). When an assigned RBG overlaps with a subband boundary, the WTRU may determine that (only) the PRBs within DL usable PRBs are to be valid for PDSCH reception and (only) the PRBs within UL usable PRBs are to be valid for PUSCH transmission, (e.g., where this may imply “partial RBG” is allowed and valid for resource allocation).

A WTRU may receive configuration information (e.g., from a BS, a node, and/or a device) for FD operation conducted by at least one device in a network. In an example, the FD operation may be conducted by a BS (e.g., a gNB, a node, a TRP, and/or a cell). The WTRU may operate in a HD mode for communicating with the BS, where the HD mode may indicate and/or imply, at a given time, that the WTRU either performs a UL transmission or a DL reception (not both simultaneously at the given time). The WTRU may operate in an FD mode for communicating with the BS (e.g., if a corresponding WTRU capability signal(s) is reported to the BS and/or the WTRU receives a confirmation signal (e.g., enabling the FD, configuring the FD mode) in response to transmitting the WTRU capability signal)).

The FD operation may indicate and/or imply that at a given time, a transmitter (e.g., the BS and/or the WTRU) may simultaneously transmit a first signal and receive a second signal. The FD operation may comprise a subband overlapping FD (e.g., in-band FD) operation where a first frequency-domain resource (e.g., RBG(s), RB(s), RE(s)) allocated for the first signal may have a full or at least a partial overlap with a second frequency-domain resource allocated for the second signal. The FD operation may comprise a subband non-overlapping FD (e.g., SBFD) operation where a first frequency-domain resource allocated for the first signal (e.g., assigned within a configured SBFD subband, e.g., DL subband, usable DL PRBs) does not have an overlap with a second frequency-domain resource allocated for the second signal (e.g., assigned within a configured SBFD subband, e.g., UL subband, usable UL PRBs).

Hereinafter, the FD operation may include and/or comprise the SBFD operation. However the embodiments and examples described herein may equally (or equivalently or extendedly, etc.) be employed (e.g., applicable) for cases with other FD operation types (e.g., IBFD).

A WTRU may receive SBFD-related configuration(s), for example, for frequency-domain location information of one or more subbands (e.g., DL subband, UL subband, flexible DL/UL subband, and/or guardband), and/or for time-domain location information of the one or more subbands. The time-domain location information may indicate a set of non-SBFD symbols and a set of SBFD symbols (e.g., as illustrated in FIG. 2). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, for example, depending on one or more conditions with other signal(s) co-existing in the symbol(s).

A WTRU may be configured with, determine to, or be indicated to measure CLI-RSSI in a given time period. The given time period may be one or more slots, OFDM symbols, RBs, and/or REs). The CLI-RSSI which may be measured in a given time and/or frequency resource may be referred to as L1-CLI-RSSI, short-term CLI-RSSI, and/or aperiodic CLI-RSSI. Alternatively, A WTRU may be configured with, determine to, or be indicated to measure RSRP based on one or more reference signals (e.g., SRS-RSRP) in the context of CLI measurement in a given time period. The given time period may be one or more slots, OFDM symbols, RBs, and/or REs. The SRS-RSRP which may be measured in a given time and frequency resource may be referred to as L1-SRS-RSRP, short-term SRS-RSRP, and/or aperiodic SRS-RSRP, SRS-RSRP-CLI.

Hereinafter, the terms “CLI-RSSI,” “L1-CLI-RSSI,” and “RSSI” may be interchangeably used but still consistent with the invention. Hereinafter, the terms “SRS-RSRP,” “SRS-RSRP-CLI,” “L1-SRS-RSRP,” and RSRP may be used interchangeably.

One or more RSSI (or RSRP) types may be used and a WTRU may be configured to perform one or more RSSI (or RSRP) types, wherein a first RSSI (or RSRP) type may be based on a measurement over a long time period (e.g., more than one slot) (e.g., L3 measurements) and the measurement is reported via a higher layer signaling (e.g., RRC, MAC) ; and a second RSSI (or RSRP) type may be based on a measurement over a short time period (e.g., L1 measurements) (e.g., one slot, within a slot, one or more OFDM symbols within a slot) and the measurement is reported via a L1 signaling (e.g., PUCCH, PUSCH, RACH, SRS). RSSI may be interchangeably used with RSRP, RSRQ, and SINR. CLI-RSSI may be interchangeably used with SRS-RSRP and SINR.

A WTRU may be configured with one or more sets of time and frequency resources for measuring CLI (e.g., SRS-RSRP) (e.g., a IE SRS-RSRP-MeasurementResourceSet) including one or more sets of configuration information of SRS-RSRP measurement resource(s) (e.g., SRS-RSRP-MeasurementResource), for example, for L1 SRS-RSRP measurement. The SRS-RSRP measurement resource configurations may include a number of SRS ports, transmission comb, time resource mapping such as start position, number of symbols, repetition, frequency resources, frequency hopping, resource type such as periodic, aperiodic, semi-persistent, sequence ID used for SRS, and so forth.

A WTRU may be configured with one or more sets of time and frequency resources for measuring CLI (e.g., CLI-RSSI) (e.g., a IE CLI-RSSI-MeasurementResourceSet) including one or more sets of configuration information of CLI-RSSI measurement resource(s) (e.g., CLI-RSSI-MeasurementResource), for example for L1 CLI-RSSI measurement. The CLI-RSSI measurement resource configurations may include CLI-RSSI measurement resource ID, starting PRB index, number of PRBs, starting symbol of the CLI-RSSI resource within a slot, number of symbols of the CLI-RSSI resource within a slot, periodicity and slot offset for the CLI-RSSI resource.

Hereinafter, the CLI measurement may comprise the CLI-RSSI measurement, however the embodiments and examples provided herein may equally (or equivalently or extendedly, etc.) be employed (e.g., be applicable) for cases with other interference and/or CLI measurements (e.g., SRS-RSRP, CLI-RSRP, etc.).

A WTRU may be configured with a set of time and frequency resources to measure L1-CLI-RSSI, wherein the time and frequency resources for L1-CLI-RSSI measurement may be referred to as CLI-RSSI Measurement Resource (CRMR).

A CRMR may be a resource configured, determined, or defined (e.g., via RRC, MAC-CE, and/or DCI) (e.g., via CLI-ResourceConfig, and/or CLI-ResourceConfig-r-16) with one or more of following properties:

A CRMR may be a resource configured, determined, or defined with a set of muted REs in downlink resource (e.g., PDSCH), wherein the muted REs may be rate-matched around or punctured for downlink reception and/or uplink transmission. The set of muted REs may have a same pattern (e.g., same time and frequency location) in each RB. The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources (e.g., CSI-RS and/or ZP-CSI-RS).

A CRMR may be a resource configured, determined, or defined with a set of REs not scheduled or used for the WTRU measuring CRMR.

A CRMR may be a resource configured, determined, or defined with a set of REs that may be located in an RB, which may be configured or determined as a guard band or guard RB. The guard band or guard RB may be located in between UL and DL resources. A WTRU may skip receiving or transmitting a signal in guard band.

A CRMR may be a resource configured, determined, or defined with one or more reference signals (e.g., DMRS, SRS, and/or sidelink CSI-RS.).

A CRMR may be a resource configured, determined, or defined with a second set of DMRS REs within a second CDM group (e.g., within a scheduled downlink resource and/or RBs, e.g., of PDSCH), where a WTRU may receive a DCI, scheduling the PDSCH, indicating a first set of DMRS Res corresponding to a first CDM group to be used for receiving the PDSCH. In an example, the WTRU may receive the DCI, scheduling the PDSCH, indicating a first set of DMRS REs corresponding to a first CDM group (based on an indicated “(DMRS) antenna port” field of the DCI). In response to receiving the DCI, the WTRU may determine that a second set of DMRS REs within a second CDM group (other than the first CDM group) may be used as the CRMR (e.g., within the scheduled PDSCH).

A CRMR may be a resource that is located within a scheduled resource (e.g., scheduled PDSCH RBs)

A CRMR may be configured commonly for a set of WTRUs (e.g., WTRUs in proximity). For example, a BS may configure a CRMR for a group of WTRUs, wherein the group of WTRUs may share one or more of following: a group-ID to receive a DCI (e.g., a group-RNTI); a zone-ID, wherein the zone-ID may be determined based on a geographical location of the WTRU (e.g., GNSS); and/or paired for sidelink unicast or groupcast transmission.

A L1-CLI-RSSI measurement (including CRMR resource) may be considered as CSI reporting quantity and configured as a part of CSI reporting setting.

A CRMR may be configured in a first subband type (e.g., DL subbands) to measure one or more reference signals received in a second subband type (e.g., UL subbands). The reference signals may be received and measured in resources that can be identified as zero-power or muted resources. The WTRU may be configured, determined, or indicated to measure the effect of reference signals being transmitted in other resources (e.g., second type resources (e.g., UL subbands)) in these resources (e.g., first type resources (e.g., DL subbands)). For example, a first WTRU may be configured to measure SRS-RSRP in DL subbands on an SBFD configuration, where the SRS is transmitted by a second WTRU in the UL subbands. For example, the first WTRU may measure SRS-RSRP based of the configured SRS signaling in the DL subbands. In another example, the WTRU may measure the CLI-RSSI based on the configured SRS signaling in the UL subbands.

A WTRU may be configured to, determine to, or indicated to perform a delta CLI-RSSI (delta-CLI-RSSI), which may be based on a first CLI-RSSI measurement in a first time and/or frequency location and a second CLI-RSSI measurement in a second time and/or frequency location. One or more of following may apply:

The delta-CLI-RSSI may be a difference between a first CLI-RSSI (e.g., CLI-RSSI1) and a second CLI-RSSI (e.g., CLI-RSSI2), for example, delta-CLI-RSSI=CLI-RSSI1−CL-RSSI2 (or delta-CLI-RSSI=CLI-RSSI2−CL-RSSI1).

The first CLI-RSSI may be measured from CRMR resources located in the edge of the scheduled RBs while the second CLI-RSSI may be measured from CRMR resources located in the middle of the scheduled RBs.

A WTRU may be configured with a first CRMR resource for the first CLI-RSSI measurement and a second CRMR resource for the second CLI-RSSI measurement.

A WTRU may determine to report CLI measurement related information when a measured delta-CLI-RSSI is larger than a threshold. For example, CLI reporting may be triggered based on delta-CLI-RSSI measurement is larger than a threshold, where the threshold may be predetermined or (pre)configured.

A WTRU may be configured to or determine to measure CLI-RSSI per subband level. For example, a subband may be configured, or predetermined, and a WTRU may perform CLI-RSSI measurement in each subband. The subband size may be determined based on the number of scheduled RBs (e.g., for PDSCH). The WTRU may report CLI-RSSI measurement for all subbands. The WTRU may report a subset of CLI-RSSI, wherein the subset may be determined based on one or more conditions (e.g., CLI-RSSI value above threshold, subband location (e.g., edge of scheduled RBs), and/or subband index).

A WTRU may determine a bandwidth of beam measurement and/or reporting (e.g., wideband or subband) based on one or more of following conditions.

A WTRU may determine a bandwidth of beam measurement and/or reporting based on a time unit type (e.g., SBFD or non-SBFD). For example, a WTRU may report wideband CRI (e.g., wideband beam index) in non-SBFD time units (e.g., symbol, slot, and so forth) and the WTRU may report subband CRI (e.g., subband beam index) in SBFD time units.

A WTRU may determine a bandwidth of beam measurement and/or reporting based on the presence of CLI-RSSI measurement. The bandwidth of beam measurement/reporting is determined based on whether CLI-RSSI is measured in the same slot or not.

A WTRU may be indicated to perform CLI-RSSI measurement in a specific frequency location within scheduled RBs or non-scheduled RBs, wherein the specific frequency location may be one or more of subbands, RBs, and REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform measurement on CRMR resource indicated in a DCI.

A WTRU may be configured with a set or subset of SR IDs that are associated with SBFD symbols, defining their applicability, usage, or assignment. When initiating an SR transmission, the WTRU may select an SR ID associated with a PUCCH that utilizes SBFD symbols, particularly in cases where the PUCCH transmission occasion overlaps with these symbols.

The selection of an SR ID associated with a PUCCH that employs SBFD symbols may depend on certain conditions. Specifically, the WTRU may choose an SR ID associated with a PUCCH that employs SBFD symbols if: (1) the CLI measurement results of the PUCCH resource corresponding to the selected SR ID are below a predefined threshold; (2) the transmission power level of the PUCCH resource corresponding to the selected SR ID is below a predefined threshold; and/or (3) the bit rate of the newly triggered data transmission is below a predefined threshold. Furthermore, the WTRU may choose an SR ID associated with a PUCCH that employs SBFD symbols if the WTRU determines that first PUCCH resource is scheduled earlier than a second PUCCH resource that employs non-SBFD symbols.

In one embodiment, a WTRU connected to a network operating in FD mode may indicate its FD support to the network. This indication may be provided through a capability report or an early notification during the random access procedure, enabling the network to optimize resource allocation and scheduling accordingly.

The WTRU may receive configuration information that includes one or more SR configurations. The WTRU may receive a first SR configuration that specifies a set of SR IDs associated with PUCCH resources, where these resources are either allocated to SBFD symbols or identified by an SBFD symbol type. Additionally, the WTRU may receive a second SR configuration that defines another set of SR IDs linked to PUCCH resources, where these resources are either assigned to non-SBFD symbols or marked with a non-SBFD symbol type.

The WTRU may then receive configuration information for a first logical channel (e.g., a low-latency channel) that is associated with both a first SR ID from the first set of SR IDs and a second SR ID from the second set of SR IDs. An SR ID from the first set of SR IDs (e.g., the first SR ID) may be associated with a CLI measurement configuration for the PUCCH resources linked to the first SR ID, along with a threshold for CLI-RSSI measurement results. Additionally, an SR ID from the first set of SR IDs (e.g., the first SR ID) may be associated with a threshold for the transmission power of the associated PUCCH resources. Furthermore, an SR ID from the first set of SR IDs (e.g., the first SR ID) may be associated with a threshold for the data bit rate. The WTRU may then perform CLI measurement on the PUCCH resources associated with the first SR ID.

When new data is triggered from the first logical channel, the WTRU may select the first SR ID from the first set of SR IDs, provided that at least one condition is met based on the corresponding configuration. In one condition, the WTRU may select the first SR ID if the CLI level (e.g., RSSI) of the first PUCCH resource associated with the first SR ID is below the configured CLI-RSSI threshold. In another condition, the WTRU may select the first SR ID if the transmission power of the SR transmission (e.g., dBm) for the first PUCCH resource associated with the first SR ID is below the configured transmission power threshold. In yet another condition, the WTRU may select the first SR ID if the newly triggered data bit rate associated with the first logical channel is lower than the configured data rate threshold. In yet another condition, the WTRU may select the first SR ID if the corresponding first PUCCH resource is scheduled earlier than a second PUCCH resource associated with the second SR ID.

The WTRU may then transmit the SR using the first PUCCH resource associated with the first SR ID, according to the determined transmission power.

If none of the above conditions are met, the WTRU may select the second SR ID from the second set of SR IDs and transmit a SR via a second PUCCH resource (e.g., on non-SBFD symbols) associated with the second SR ID.

In one example, the WTRU may first determine whether first PUCCH resource is scheduled earlier than the second PUCCH resource. If the first PUCCH resource is scheduled earlier than the second PUCCH resource, the WTRU may then proceed to determine whether the other conditions are satisfied (i.e., CLI levels, transmission power level, and bit rate levels). However, if the WTRU determines that the first PUCCH resource is not scheduled earlier than the second PUCCH resource, the WTRU may determine to use the second PUCCH regardless of whether the other conditions are satisfied. In another example, the WTRU may prioritize the conditions. For example, if the WTRU determines that the CLI levels are above the configured threshold, it may determine to use the second PUCCH regardless if any of the other conditions are satisfied.

A WTRU may transmit capability information to the network, indicating whether it supports FD operation. The capability information may specify FD support along with the ability to perform CLI measurements, such as layer-1 (L1)-CLI-RSSI, L1-SRS-RSRP, layer-3 (L3)-CLI-RSSI, and L3-SRS-RSRP. Additionally, the WTRU may report its capability to transmit a preamble during the RACH procedure, including support for an additional RO (region) applicable to full-duplex operation. Upon receiving this capability information, the network may configure the WTRU with full-duplex settings, such as the additional RO region, RO selection rules, and any configurations related to the RACH procedure in full-duplex operation.

A WTRU may be configured with one or more SR configurations from the network. For example, a BS may transmit, to the WTRU, configuration information that includes one or more logical channels. For example, the network may transmit this configuration information via RRC SIB and/or RRC dedicated message. Each of the SR configurations may include an SR ID and a set of PUCCH resources (e.g., first PUCCH resource and/or a second PUCCH resource). The WTRU may select a PUCCH resource for SR transmission among the configured set of PUCCH resources, for example, based on when an UL grant (e.g., BSR transmission and/or following UL data transmission) is necessary (e.g., preferred to be granted on which symbol type (of non-FD or FD symbols), in the WTRU perspective).

A WTRU may be configured with one or more logical channels (e.g., associated data radio bearer). For example, the WTRU may be configured with one or more logical channels upon receiving configuration information from the network. Each of the one or more logical channels for UL data (e.g., new data for transmission from the application layer) may be associated with a target/required QoS/priority value/service with associated with latency requirements (e.g., the priority level is high and/or the required latency is small). Each of the configured logical channels may be associated with one or more scheduling request IDs (e.g., a subset of SR IDs among all configured SR IDs). For example, when a new data is triggered with the logical channel, the WTRU may determine the scheduling request ID associated with the logical channel of the new data being triggered (e.g., out of all the configured SR IDs). Upon selecting the SR ID, the WTRU may perform an SR transmission based on a PUCCH resource associated the selected SR ID.

A WTRU may receive configuration information that includes one or more logical channels for SR transmission in a FD (e.g., SBFD) operation. The one or more logical channels may be configured to support specific QoS or priority requirements, particularly for traffic with latency constraints that fall below a defined threshold (e.g., in slots or milliseconds). Additionally, the WTRU may be configured with logical channels, either cell-specific or dedicated, for SBFD operation, where the configuration includes the available SBFD symbols in a TDD system (e.g., FD slots or symbols). Furthermore, the WTRU may be assigned logical channels that either utilize or are associated with both SBFD and non-SBFD symbols.

In one example, a WTRU may receive, from a network. configuration information that includes logical channels and associated multiple sets of SR IDs (e.g., first set of SR IDs and/or second set of set IDs). Each of the first set and second set of SR IDs may include one or more SR IDs (e.g., a first SR ID and/or a second SR ID).

The first set of SR IDs may be associated with a first set of PUCCH resources and the second set of SR IDs may be associated with a second set of PUCCH resources. The first set of SR ID may be associated with the first set of PUCCH resources that comprise SBFD symbols (e.g., assigned in SBFD symbols/slots, or tagged with a SBFD symbol type). The second set of SR IDs may be associated with the second set of PUCCH resources that comprise non-SBFD symbols (e.g., assigned in non-SBFD symbols/slots, or tagged with a non-SBFD symbol type). Each of the PUCCH resources (e.g., the first PUCCH resource and/or the second PUCCH resource) may be configured with and/or associated with a periodicity and an offset (e.g., milliseconds/symbols/slots).

The first PUCCH resource may indicate one of the PUCCH resources (e.g., the earliest resource) among the configured one or more periodic PUCCH resources (e.g., the first set of PUCCH resources). For example, after a WTRU selects an SR ID, the WTRU may select one of the PUCCH resource (e.g., configured earliest) among the configured PUCCH resources (e.g., the first set of PUCCH resources) which is associated with the selected SR ID. For example, the WTRU may not select one of the PUCCH resource associated the selected SR ID, if the PUCCH resource (e.g., the third PUCCH resource) is not configured with non-SBFD symbols.

For example, the WTRU may be configured with one logical channel that is associated with one or more SR IDs (e.g., a first SR ID of the first set and/or a second SR ID of the second set). For example, the WTRU may be configured with multiple logical channels, where one or more of the logical channels is associated with a first SR ID of the first set and/or a second SR ID of the second set.

In one example, a WTRU may be configured with a first set of SR IDs along with related configuration information and conditions for selecting an SR ID from the first set of SR IDs set. The selection criteria may include factors such as a CLI level threshold, a transmission power threshold, a bit rate threshold, specific configuration parameters, and the type of data service being used. Additionally, the selection may be made between SR IDs from the first set of SR IDs and those from a second set of SR IDs, based on these conditions.

A WTRU may be configured with a CLI level threshold. The WTRU may measure the CLI level of the subband (e.g., PUCCH resource and/or PUSCH resources) which is configured for full duplexing mode. For example, a WTRU may receive configuration information that includes a first set SR IDs and associated CLI measurement configurations. The CLI measurement configuration (e.g., frequency resource, time slots) may indicate and/or include one or more PUCCH resources associated with the first SR ID of the first set of SR IDs. The CLI measurement configuration may indicate and/or configure consecutive PUCCH resources (e.g., first PUCCH and second PUCCH among the PUCCH resources) or PUSCH resources (e.g., scheduled SBFD resource) associated the SR ID (e.g., first SR ID). The WTRU may measure a CLI-RSSI level based on the CLI measurement configuration (e.g., L1-CLI-RSSI, long/short-term CLI-RSSI, periodic/aperiodic CLI-RSSI, RSRP, and/or SRS-RSRP). The WTRU may be configured with a CLI threshold level that indicates a minimum and/or allowed interference level for successful SR transmission via the PUCCH resource associated with the SR ID. For example, the CLI threshold level may be associated with the measured value of the PUCCH resources (e.g., first PUCCH and/or second PUCCH) associated the first set of SR IDs.

A WTRU may be configured with a transmission power threshold. For example, the WTRU may receive configuration information that includes a first set of SR IDs and a threshold of the maximum transmission power (e.g., dBm). For example, the threshold may be the maximum transmission power if the WTRU transmit the SR ID (e.g., of the first set SR IDs) associated with the PUCCH resources (e.g., first PUCCH resource and/or second PUCCH resource). The WTRU may determine the transmission power of the PUCCH resources based on received DL-RSRP level or closed-loop power control. For example, the WTRU may be configured with a transmission power threshold (e.g., minimum power level) of the PUCCH resources (e.g., first PUCCH and/or second PUCCH) associated the first set of SR ID.

The WTRU may be configured with a bit rate threshold. For example, the WTRU may receive configuration information that includes a first set SR IDs and an associated a threshold of the minimum data bit rate (e.g., bits/bytes) and/or required size of UL grant (e.g., slots/band). For example, the threshold may be the minimum bit rate of the triggered new data from the logical channel which is associated with first set SR IDs.

A WTRU may receive configuration information that includes a first set of SR IDs and a second set of SR IDs, each associated with one or more logical channels. The WTRU may be configured with a logical channel (e.g., a designated full-duplex logical channel) that is associated with SBFD symbols. Additionally, the WTRU may be configured with another logical channel (e.g., a designated legacy logical channel) that is associated with non-SBFD symbols.

A WTRU may be configured with a specific type of data service. For example, the configuration information may assign the WTRU with a particular data service, such as URLLC and/or low-latency communication, along with an associated first set of SR IDs. When this specific data service is triggered (e.g., through an indication, application ID, or session ID received from upper layers), the WTRU, in conjunction with one or more logical channels, may determine the need for SR transmission. Upon receiving the service indication, the WTRU may initiate an SR transmission using the first set of SR IDs.

A WTRU may receive, from a network, configuration information that includes one or more logical channels where each of the logical channels is associated multiple sets of SR IDs. The first set of SR IDs and the second set of SR IDs may each include one or more SR IDs. For example, the WTRU may be configured one logical channel.

For example, the WTRU may be configured with a first set of SR IDs and associated conditions specifying when the WTRU is to select an SR ID from the first or second set of SR IDs (e.g., based on data triggered from a particular logical channel, such as the first logical channel). Upon determining that one or more of these conditions are met, the WTRU may select an SR ID from the first set and the corresponding PUCCH resource.

The WTRU may determine to select an SR ID from the first set of SR IDs based on a CLI level threshold. The WTRU may receive configuration information that includes a first set SR IDs and CLI measurement configuration information. For example, the WTRU may be configured a CLI level threshold (e.g., minimum/allowed interference level for successful SR transmission) of the PUCCH resources associated with the first set of SR IDs. The WTRU may perform the CLI measurement of a PUCCH resource according to the received CLI configuration associated with the first set of SR IDs.

The WTRU may determine to select an SR ID (e.g., the first SR ID) from the first set of SR IDs based on the CLI measurement results of PUCCH resources and the of CLI level threshold (e.g., L1-CLI-RSSI, long/short-term CLI-RSSI, (a)periodic CLI-RSS, RSRP, SRS-RSRP). For example, a WTRU may consider selecting one or more PUCCH resources associated the first SR ID, if the measured CLI level associated one or more PUCCH resources (e.g., the first PUCCH and/or second PUCCH) are below the CLI level threshold. The WTRU may determine to select the first SR ID associated with the first PUCCH resource (e.g., selecting the earliest available resource among the available candidate resources) for an SR transmission, if the measured CLI level of the first PUCCH resource and the second PUCCH resource are below the threshold.

The WTRU may determine to select an SR ID from the first set of SR IDs based on a transmission power threshold. In one example, the WTRU may be configured with a transmission power threshold (e.g., minimum power level) of the PUCCH resources (e.g., first PUCCH and/or second PUCCH) associated the first set of SR IDs. For example, a WTRU may select one or more PUCCH resource associated the first SR ID if the estimated transmission power (e.g., based on DL-RSRP or closed-loop power control) of the associated PUCCH resources (e.g., the first PUCCH and/or the second PUCCH) for SR transmission is below a transmission power level threshold. For example, the WTRU may determine to select first SR ID associated the first PUCCH resource (e.g., selecting the earliest available resource among the available candidate resources) for an SR transmission, if the estimated transmission power of the first PUCCH resource and second PUCCH resource is below the transmission power level threshold.

The WTRU may determine to select an SR ID from the first set of SR IDs based on a bit rate threshold. For example, a WTRU may receive a configuration information comprising the first set SR IDs and an associated bit rate threshold of the minimum data bit rate (e.g., bits/bytes) and/or required size of UL grant (e.g., slots/band). For example, the threshold may be the minimum bit rate of the triggered new data from the logical channel that is associated with first set SR IDs. The WTRU may determine to select an SR ID of the first set if the bit rate of the new triggered data is below the configured threshold and/or if the size of request UL grant of new triggered data is below the configured threshold.

The WTRU's selection of an SR ID from the first set of SR IDs may be configuration-based. In one example, the WTRU may receive configuration information specifying a first set and a second set of SR IDs, each associated with one or more logical channels. For instance, the WTRU may be configured with a logical channel (e.g., a designated full-duplex logical channel) associated with SBFD symbols. The WTRU may select an SR ID from the first set if new data is triggered from a logical channel configured as a full-duplex logical channel. Additionally, the WTRU may select an SR ID from the first set if the new data is triggered from a logical channel designated as high priority (e.g., low latency).

The WTRU may determine to select an SR ID from the first set of SR IDs based on the type of data service. A WTRU may be configured with a specific data service (e.g., URLLC, low latency, emergency case) and first set of SR IDs. For example, a WTRU may determine to select an SR ID from the first set of SR IDs if the new data is triggered and a specific data service (e.g., low latency service, low latency requirement) is indicated from an upper layer (e.g., indication/application ID/session ID of data service from upper layers).

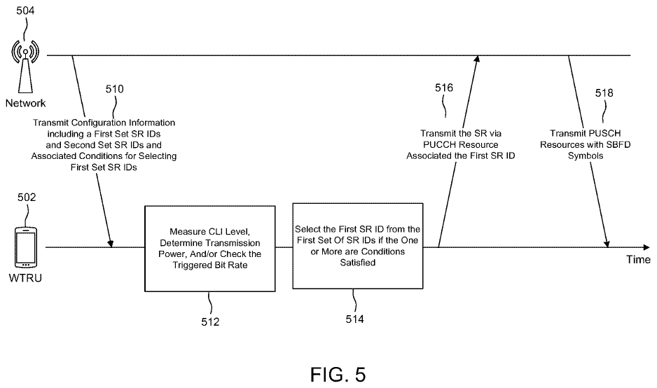

FIG. 5 illustrates an exemplary signaling diagram for SR ID selection. At 510, the WTRU 502 may receive, from the network 504, configuration information including multiple sets of SR IDs (e.g., first set of SR IDs and/or a second set of SR IDs) and conditions (e.g., thresholds, CLI measurement configuration, and/or bit rates) for selecting a SR ID of the first set SR IDs.

At 512, the WTRU 502 may: (1) measure CLI levels based on the received configuration information, (2) determine transmission power and/or (3) check the bit rate of the triggered new data. For example, the WTRU may determine to select the SR ID of the first set of SR IDs if at least one of the configured conditions is satisfied.

At 514, the WTRU 502 may determine to select the first SR ID if: (1) the measured CLI level associated PUCCH resource is lower than the received CLI level threshold, (2) the transmission power associated with the PUCCH resource is lower than the received transmission power threshold; and/or (3) the bit rate of the triggered new data is below the received bit rate threshold. At 516, if at least one of the conditions is satisfied, the WTRU 502 may transmit, to the network 505, an SR via the PUCCH resource with SBFD symbols. At 518, the WTRU 502 may receive, from the network 504, a UL grant including SBFD symbols and/or information on how to transmit a PUSCH scheduled by the UL grant (e.g., the PUSCH to be transmitted on SBFD symbols). Based on the UL grant, the WTRU 502 may transmit the PUSCH, on SBFD symbols, scheduled by the UL grant (e.g., where the UL grant may be allowed to be received on non-SBFD symbols or may be only valid when received in SBFD symbols, based on the network's configuration or indication).

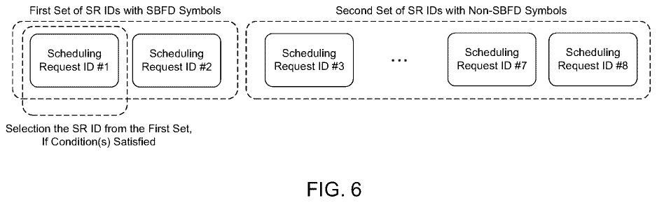

FIG. 6 illustrates an exemplary selection of the SR ID form the first set of SR IDs. For example, if at least one of the above described conditions is satisfied, a WTRU may select the SR ID with SBFD symbols from the first set of SR IDs. If none of the conditions are satisfied, the WTRU may select the SR ID with non-SBFD symbols from the second set of SR IDs.

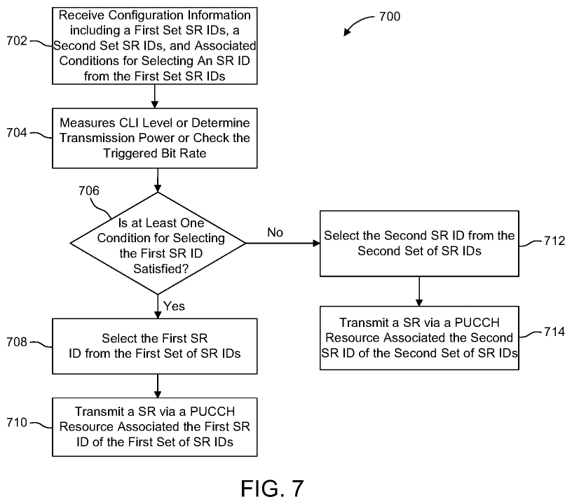

FIG. 7 is illustrates an exemplary SR ID selection process 700 performed by a WTRU. At 702, the WTRU may receive configuration information that includes a first set of SR IDs and a second set of SR IDs and conditions for selecting a SR ID from the first set SR IDs. At 704, the WTRU may: (1) measure CLI levels based on the received configuration information, (2) determine transmission power and/or (3) check the bit rate of the triggered new data. At 706, the WTRU may determine if one of the conditions included in the configuration information for selecting an SR ID from the first set of SR IDs is satisfied. At 708, if at least one of the conditions at 706 is satisfied, the WTRU may select the first SR ID from the first set of SR IDs. At 710, the WTRU may transmit the selected SR via a PUCCH resource associated with the first SR ID from the second set of SR IDs.

If, at 706, the WTRU determines that none of the conditions included in the configuration information are satisfied, at 712, the WTRU may determine to select the second SR ID from the second set of SR IDs. At 714, the WTRU may transmit the SR via a PUCCH resource associated with the second SR ID from the second set of SR IDs.

A WTRU may receive configuration information associated multiple sets of SR IDs from network. Each of the sets of SR IDs may include one or more SR IDs. The WTRU may perform an SR transmission via a first PUCCH resource associated with a first SR ID from a first set of SR IDs. If the WTRU does not receive a UL grant (e.g., a failure of the SR transmission), it may retransmit the SR using a second PUCCH resource associated with a second SR ID from a second set of SR IDs.

A WTRU may perform multiple consecutive SR transmissions to increase the success rate of SR transmission using one or more PUCCH resources, such as the first and second SR transmissions. The network may send an activation indication to the WTRU, authorizing multiple SR transmissions. Upon receiving this activation, the WTRU may transmit the first SR transmission using the first PUCCH resource, which may include SBFD symbols, associated with the first SR ID of the first set of SR IDs. The WTRU may then transmit the second SR transmission using a second PUCCH resource, which may include non-SBFD symbols, associated with the second SR ID of the second set of SR IDs.

A WTRU may receive, from the network, configuration information with one or more logical channels that are associated multiple sets of SR IDs (e.g., a first set of SR IDs and/or a second set of set IDs). For example, upon transmitting an SR via the PUCCH associated with the first SR ID from the first set of SR IDs, the WTRU may receive an UL grant (e.g., SBFD symbols or non-SBFD symbols) from the network.

In one example, upon receiving an UL grant with SBFD symbols, the WTRU may send a buffer status report (BSR) and/or power headroom report (PHR) which may be associated with SBFD symbols (e.g., an SBFD symbol type, an FD symbol type). The WTRU may send a BSR that includes the one or more configured logical channels, for example with the corresponding logical channel ID(s) and the associated first set of SR IDs with SBFD symbols (e.g., an SBFD symbol type and/or an FD symbol type). For example, the WTRU may send the PHR including the power headroom values with PUCCH and/or PUSCH resource associated with first set of SR IDs (e.g., SBFD-symbols, an SBFD symbol type, and/or an FD symbol type).

In one example, upon receiving an UL grant with non-SBFD symbols, the WTRU may report BSR and PHR which may be associated with (e.g., both of) SBFD-symbols and non-SBFD symbols. For example, the WTRU may report BSR including the logical channel groups associated with the first set of SR IDs with SBFD symbols and associated with the second set of SR IDs with non-SBFD symbols. For example, the WTRU may report PHR including the power headroom values with PUCCH and/or PUSCH resource associated with the first set of SR IDs (e.g., SBFD-symbols) and the second set SR IDs (e.g., non-SBFD symbols).

In an example, the WTRU may be configured (or indicated) to determine separate BSRs each for a different FD type, where the WTRU may (be configured to) determine (e.g., manage, update, maintain) a first BSR associated with the SBFD symbol type and a second BSR associated with the non-SBFD symbol type. In response to receiving the UL grant (e.g., scheduling a PUSCH to be transmitted on non-SBFD symbols), the WTRU may determine to include both the first BSR and the second BSR into the PUSCH (e.g., into a MAC-CE message component of the PUSCH), for example, for the purpose of aiding the network's further scheduling decision to consider scheduling on SBFD symbols based on the reported first BSR (e.g., not only based on the second BSR). This may provide benefits in that the network may distinctively optimize resource allocation across different FD symbol types based on the separately reported BSRs (first and second BSR) from the WTRU. When the PUSCH is scheduled on SBFD symbols by the UL grant, the WTRU may include (only) the first BSR into the PUSCH, as it may correspond to the WTRU's SR transmission with one of the first set of SR IDs (e.g., requesting the UL grant on SBFD symbols).

In an example, the WTRU may be configured (or indicated) to determine separate PHRs each for a different FD type, where the WTRU may (be configured to) determine (e.g., manage, update, maintain) a first PHR associated with the SBFD symbol type and a second PHR associated with the non-SBFD symbol type. In response to receiving the UL grant (e.g., scheduling a PUSCH to be transmitted on non-SBFD symbols), the WTRU may determine to include both the first PHR and the second PHR into the PUSCH (e.g., into a MAC-CE message component of the PUSCH), for example, for the purpose of aiding the network's further scheduling and/or power control decision to consider scheduling on SBFD symbols based on the reported first PHR (e.g., in terms of appropriate UL Tx power level on SBFD symbols). This may provide benefits in that the network may distinctively optimize UL Tx power control across different FD symbol types based on the separately reported PHRs (first and second PHR) from the WTRU. In an example, when the PUSCH is scheduled on SBFD symbols by the UL grant, the WTRU may include (only) the first PHR into the PUSCH, as it may correspond to the WTRU's SR transmission with one of the first set of SR IDs (e.g., requesting the UL grant on SBFD symbols).

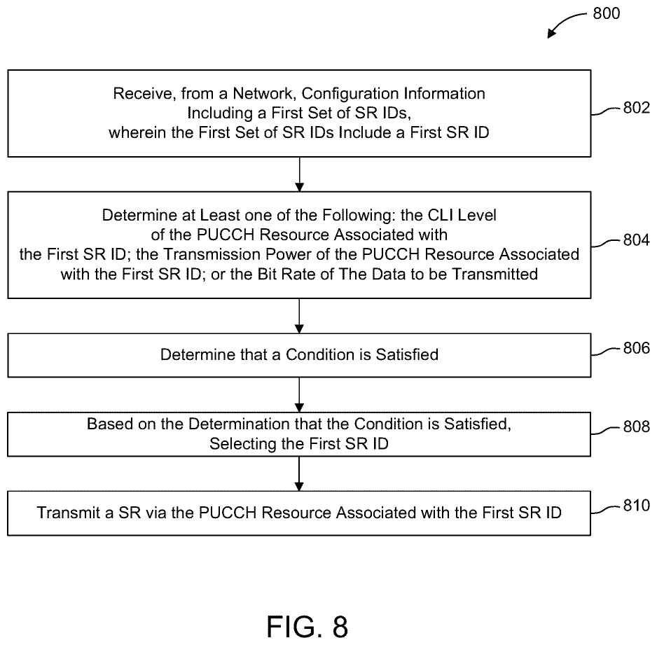

FIG. 8 illustrates an exemplary SR ID selection process 800 performed by a WTRU. At 802, the WTRU may receive, from a network, configuration information that includes a first set of SR IDs, where the first set SR IDs include a first SR ID. At 804, the WTRU may determining at least one of the following: (1) the CLI level of the PUCCH resource level of a first PUCCH resource associated with the first SR ID; (2) the transmission power of the first PUCCH resource; and/or (3) the bit rate of the data to be transmitted. At 806, the WTRU may determine that a condition is satisfied. The condition may be satisfied if one or more of the following is satisfied: (1) the CLI level is below a configured CLI threshold; (2) the transmission power is below a transmission power threshold; and/or (3) the bit rate is below a data bit rate threshold. At 808, based on determining that at least one of the above conditions is satisfied, the WTRU may select the first SR ID. At 810, the WTRU may transmit a SR via the PUCCH resource associated with the first SR ID. The PUSCH resources associated with the first SR ID may include SBFD symbols.

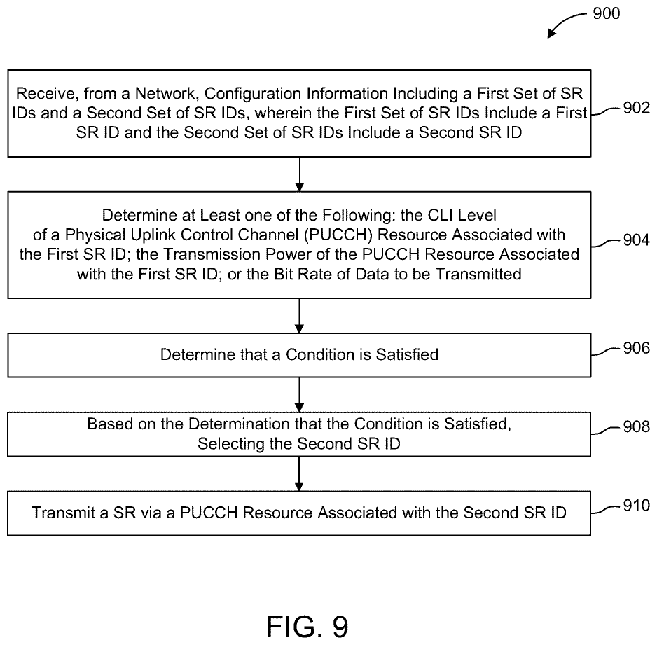

FIG. 9 illustrates an exemplary SR ID selection process 900 performed by a WTRU. At 902, the WTRU may receive, from a network, configuration information that includes a first set of SR IDs and a second set of SR IDs, where the first set SR IDs include a first SR ID and the second set of SR IDs include a second SR ID. At 904, the WTRU may determining at least one of the following: (1) the CLI level of a first PUCCH resource associated with the first SR ID; (2) the transmission power of the first PUCCH resource; and/or (3) the bit rate of data to be transmitted. At 906, the WTRU may determine that a condition is satisfied. The condition may be satisfied if one or more of the following is satisfied: (1) the CLI level is above a configured CLI threshold; (2) the transmission power is above a transmission power threshold; and/or (3) the bit rate is above a data bit rate threshold. At 908, based on determining that at least one of the above conditions is satisfied, the WTRU may select the second SR ID. At 910, the WTRU may transmit a SR via the PUCCH resource associated with the second SR ID. The PUSCH resources associated with the second SR ID may include non-SBFD symbols.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from a network, configuration information including a first set of scheduling request (SR) IDs, wherein the first set of SR IDs includes a first SR ID;
determining at least one of the following:
(a) a cross-link interference (CLI) level of a first physical uplink control channel (PUCCH) resource associated with the first SR ID;
(b) a transmission power of the first PUCCH resource associated with the first SR ID; or
(c) a bit rate of data to be transmitted;
determining that a condition is satisfied;
based on the determination that the condition is satisfied, selecting the first SR ID; and
transmitting a SR via the first PUCCH resource associated with the first SR ID.

2. The method of claim 1, further comprising:
receiving, from the network, physical uplink shared channel (PUSCH) resources, wherein the PUSCH resources include subband non-overlapping full duplex (SBFD) symbols.

3. The method of claim 1, wherein the configuration information further includes at least one of a CLI level threshold, a transmission power threshold, and a bit rate threshold.

4. The method of claim 1, wherein the condition is satisfied if the CLI level is below a configured CLI threshold.

5. The method of claim 1, wherein the condition is satisfied if the transmission power is below a transmission power threshold.

6. The method of claim 1, wherein the condition is satisfied if the bit rate is below a data bit rate threshold.

7. The method of claim 1, wherein a transmission power of the SR transmission is the determined transmission power of the first PUCCH resource.

8. The method of claim 1, wherein the first PUCCH resource associated with the first SR ID includes subband non-overlapping full duplex (SBFD) symbols.

9. The method of claim 1, wherein the configuration information further includes a second set of SR IDs including a
second SR ID, wherein the second SR ID is associated with a second PUCCH resource 10. The method of claim 9, further comprising:
determining that the second PUCCH resource occurs earlier in time than the first PUCCH resource;
based on the determination that the second PUCCH occurs earlier in time than the first PUCCH resource, selecting the second SR ID.

11. A method performed by a wireless transmit/receive unit (WTRU), the method comprising:
receiving, from a network, configuration information including a first set of scheduling request (SR) IDs and a second set of SR IDs, wherein the first set of SR IDs includes a first SR ID and the second set of SR IDs include a second SR ID;
determining at least one of the following:
(a) a cross-link interference (CLI) level of a physical uplink control channel (PUCCH) resource associated with the first SR ID included in the first set of SR IDs;
(b) a transmission power of the PUCCH resource associated with the first SR ID included in the first set of SR IDs; and
(c) a bit rate of data to be transmitted;
determining that a condition is satisfied;
based on the determination that the condition is satisfied, selecting the second SR ID included in the second set of SR IDs; and
transmitting a SR via a PUCCH resource associated with the second SR ID.

12. The method of claim 11, wherein the condition is satisfied if:
the CLI level is above a configured CLI threshold;
the transmission power is above a transmission power threshold; and
the bit rate is above a data bit rate threshold.

13. The method of claim 11, wherein the PUCCH resource associated with the second SR ID includes non-subband non-overlapping full duplex (non-SBFD) symbols.

14. The method of claim 11, wherein the first SR ID and the second SR ID are associated with the same logical channel.

15. A wireless transmit/receive unit (WTRU) configured to:
receive, from a network, configuration information including a first set of scheduling request (SR) IDs and a second set of SR IDs, wherein the first set of SR IDs include a first SR ID and the second set of SR IDs include a second SR ID;
determine at least one of the following:
(a) a cross-link interference (CLI) level of a physical uplink control channel (PUCCH) resource associated with the first SR ID;
(b) a transmission power of the PUCCH resource associated with the first SR ID; and
(c) a bit rate of data to be transmitted;
determining whether a condition is satisfied;
on a condition that the condition is satisfied:
select the first SR ID included in the first set of SR IDs; and
transmit a first SR via the first PUCCH resource associated with the first SR ID;
on a condition that the condition is not satisfied:
select the second SR ID; and
transmit a second SR via a second PUCCH resource associated with the second SR ID.

16. The WTRU of claim 15, wherein the condition is satisfied if at least one of the following is satisfied:
the CLI level is below a configured CLI threshold;
the transmission power is below a transmission power threshold; or the bit rate is below a data bit rate threshold.

17. The WTRU of claim 15, wherein the condition is not satisfied if:
the CLI level is above a configured CLI threshold;
the transmission power is above a transmission power threshold; and
the bit rate is above a data bit rate threshold.

18. The WTRU of claim 15, wherein the PUCCH resource associated with the first SR ID includes subband non-overlapping full duplex (SBFD) symbols.

19. The WTRU of claim 15, wherein the PUCCH resource associated with the second SR ID includes non-subband non-overlapping full duplex (non-SBFD) symbols.

20. The WTRU of claim 15, wherein the first SR ID and the second SR ID are associated with the same logical channel.
